(19) United States
(12) Patent Application Publication
(10) Pub. No.: US 2002/0071403 A1
(43) Pub. Date: Jun. 13, 2002

(54) Method and system for performing a CDMA soft handoff

(76) Inventors: M. Shane Crowe, Sachse, TX (US); Hong Ren, Nepean (CA); Mazin Al-Shalash, Plano, TX (US); Miroslav Budic, Dallas, TX (US); Trevor T. Plestid, Ottawa (CA)

Correspondence Address: David L. McCombs, Haynes and Boone, LLP, 901 Main Street, Suite 3100, Dallas, TX, 75202-3789, US

(21) Appl. No.: 09/732,247

(22) Filed: Dec. 7, 2000

(51) Int. Cl. H04Q 7/00

(52) U.S. Cl. 370/331

(57) ABSTRACT

Disclosed is a method and system for performing a handoff in a wireless communication system including receiving a communications signal from a mobile unit. The communications signal includes a phase offset from a pilot signal from one of the neighboring base station transceivers. A handoff process to one of the neighboring base station transceivers is then initiated and an ambiguity is detected by determining whether the phase offset from the pilot signal is in two neighbor search windows for two neighboring base station transceivers. If the ambiguity is detected, the search window for an active set of neighboring base station transceivers is widened so that the mobile unit can identify the pilot signal with the correct base station transceiver. If the ambiguity is detected, the hand off process is paused until the mobile unit can analyze all of the pilot signals from the neighboring base stations.

### TECHNICAL FIELD

The invention relates generally to cellular communication networks and, particularly, to a method and system for controlling the communications “handoff” between a mobile unit and cell base stations in a cellular communications system.

### BACKGROUND OF THE INVENTION

In cellular communications systems, a service area is divided into cells, each of which may be further divided into sectors. Each cell is served by a single base station transceiver subsystem (“BTS”), and each base station is connected to a mobile switching center (“MSC”) via a base station controller (“BSC”) and appropriate hardware links. A mobile unit is connected to the MSC by establishing a radio frequency (“RF”) link with a nearby BTS.

The RF links transfer information over a variety of communication channels. Such channels include traffic channels for transmitting voice (or data) signals, and pilot channels for transmitting pilot signals, wherein the pilot signals are used primarily for power measurement (to initiate call establishment, handoffs, etc.) and to allow the mobile units to perform coherent demodulation of traffic channel signals. Traffic channels and pilot channels are well-known in the art, and the manner in which these (and other) channels are defined depends on the specific implementation of the wireless communication system.

Currently, there are several different types of cellular access technologies for implementing a cellular communication network, including, for example, time division multiple access (“TDMA”), advanced mobile phone services (“AMPS”), and code division multiple access (“CDMA”). In a CDMA network, a single radio frequency is used simultaneously by many mobile units and each mobile unit is assigned a “code” for deciphering its particular traffic on that frequency. In contrast, in AMPS networks, each mobile unit is assigned a different radio frequency on which to communicate.

In operation, as the mobile unit travels away from a first BTS and toward a second BTS, the RF link between the mobile unit and the first BTS will eventually become too weak to support communications therebetween and will eventually disconnect, resulting in the call in progress being dropped. To avoid this problem, as the mobile unit nears the second BTS, a new communications path between the mobile unit and the MSC, comprising a RF link between the mobile unit and the second BTS and hardware links between the second BTS and the MSC, is established. At this point, the mobile unit is directed to end communication with the first BTS and begin communication with the second BTS.

The process of a mobile unit's terminating communication with one BTS and commencing communication with another BTS is commonly referred to as “handoff.” When mobile communications are firmly established with the new base station, e.g., the mobile is well within the new cell, the old base station discontinues servicing the call. This handoff technique is called a “soft” handoff between base stations.

In a CDMA cellular communication system, each BTS transmits its own unique pilot carrier signal, or “pilot signal,” on a pilot channel. The pilot signal is an unmodulated, direct sequence, spread spectrum signal continuously transmitted by each BTS using a common pseudo-random noise (PN) spreading code. The pilot signal allows the mobile units to obtain initial system synchronization, e.g., timing, in addition to providing a phase reference for coherent demodulation and a reference for signal strength for comparisons between base stations for handoff determination.

Because mobile units typically move between BTSs, mobile units continually scan for (e.g., measure the strength of) pilots in a search window around the spreading (or PN) sequence phase offsets where neighbor base stations are known to be transmitting. A BSC obviously knows of neighboring BTSs. The BSC helps the mobile unit identify the pilots from neighboring BTSs by sending the mobile unit the PNs for the neighboring BTSs. In other words, the BTS tells the mobile where to look for the pilots from neighboring BTS.

The arrival time for each pilot signal is measured relative to the mobile's zero time reference in units of PN chips. The mobile unit then computes and reports to the BSC a pilot PN phase (e.g., phase or time offset). For instance, if a neighboring BTS is broadcasting a pilot signal at a PN of 104, the mobile unit should see this pilot signal at 104 PNs (or 104 PN chips or 84.656 microseconds) from its zero time reference. However, the signal may not always be received by the mobile at precisely the PN of 104 because of the travel time of the radio signal. Furthermore, the signal path is not always straight and may bounce off of buildings or other structures causing additional delays. Consequently, the mobile unit may actually see the pilot signal at, for example, 104.5 PN chips from its time reference point.

The BSC, therefore, directs the mobile unit to look in a particular range or “window” for the pilot signal of the neighboring BTSs. This range is called a neighbor search window, which is a user definable number of chips.

A problem exits where the neighbor search window from two different neighboring BTSs overlap. The mobile unit may not know which BTS to associate the pilot signal. The IS-95 telecommunications standard does not define how the mobile unit nor the BSC should associate the pilot signal with either BTS. Thus, the mobile unit may associate the pilot signal with one BTS while the BSC associates it with another. If the BSC responds with a PN that the mobile has not pre-associated with the pilot signal, the mobile has trouble establishing communications during a soft handoff and the call may be dropped.

Accordingly, special intelligence must be built into the CDMA network equipment and special deployment considerations must be observed to make such soft handoffs work reliably. Therefore, what is needed is a method of detecting and resolving ambiguous pilot signals.

### SUMMARY OF THE INVENTION

Provided is a unique method and system for performing a handoff in a wireless communication system. In one embodiment, the method comprises receiving a communications signal from a mobile unit, where the communications signal includes a phase offset from a pilot signal from one of the neighboring base station transceivers. Once the communications signal is received, a handoff process to one of the neighboring base station transceivers is initiated. During the handoff process, an ambiguity can be detected by determining if the phase offset is in a neighbor search window for both neighboring base station transceivers. If so, the ambiguity is resolved by associating the phase offset with the first neighboring base station transceiver. The handoff process can therefore complete to the first neighboring base station transceiver.

In one embodiment, if the ambiguity is detected, the search window for the active set is widened so that the mobile unit can identify the pilot signal with the correct base station transceiver.

In another embodiment, if the ambiguity is detected, the hand off processing is paused until the mobile unit can analyze all of the pilot signals from the neighboring base stations.

### BRIEF DESCRIPTION OF THE DRAWINGS

FIG. 1 is a portion of a communications system and network that may employ various embodiments of the present invention.

FIG. 2 is a flow chart of a method for implementing a handoff process in the communications network of FIG. 1.

FIG. 3 is a flowchart illustrating a method in accordance with one embodiment of the present invention.

FIG. 4 is a flowchart illustrating a method used by one embodiment of the present invention.

FIG. 5 is a time line showing a mobile unit's zero time reference point and the designated locations for phase offsets of pilot signals from the zero time reference point.

FIG. 6 is a time line illustrating a mobile unit's zero time reference point and pilot signals at particular phases or time offsets from the zero time reference point.

FIG. 7 is a time line illustrating a mobile unit's zero time reference point and pilot signals at particular phases or time offsets from the zero time reference point.

FIG. 8 is a time line illustrating a mobile unit's zero time reference point and pilot signals at particular phases or time offsets from the zero time reference point.

FIG. 9 is a communications sequence chart according to one embodiment of the present invention.

FIG. 10 is a flowchart illustrating a method in accordance with one embodiment of the present invention.

FIG. 11 is a communications sequence chart according to another embodiment of the present invention.

### DETAILED DESCRIPTION

The present invention provides a unique method and system for performing a handoff in a wireless communication system. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims.

The following disclosure is divided into four different sections. The first section describes an exemplary wireless telecommunication system and network. The exemplary system and network identify an environment for implementing various embodiments of the present invention. The second section discusses exemplary methods and software routines. The methods and software routines can implement several different embodiments for correctly performing a soft handoff. The soft handoff is performed by detecting and correcting any ambiguities. The ambiguity can be detected and corrected by various methods, such as those discussed in the third and fourth sections.

Exemplary Network and System

Referring to FIG. 1, an exemplary wireless communications system and network 100 is shown for implementing various embodiments of the present invention. For the sake of example, the network/system 100 utilizes CDMA modulation techniques based on the TIA/EIA/IS-95-A, Mobile Station-Base Station compatibility Standard for Dual-Mode Wideband Spread Spectrum Cellular System (hereinafter “IS-95”), which is hereby incorporated by reference in its entirety. It should be apparent to one of ordinary skill in the art that the present invention can be equally applicable to similar wireless communication systems employing other CDMA techniques (e.g., ones based on the ANSI J 008 standard) or those employing other types of multiple access techniques, such as time division multiple access (TDMA), frequency division multiple access, etc.

The network 100 includes a plurality of nodes, represented by a MSC 102, BTSs 104, 106, and 108, and BSCs 112, 114. The MSC 102 includes interface and processing circuitry for providing system control to the various nodes. However, it is understood that in other embodiments, such control may be distributed among various nodes in the network 100. The MSC 102 also controls the routing of telephone calls, such as from a public switched telephone network (PSTN) to a mobile unit 110, and vice versa.

The MSC 102 is coupled to the BSCs 112 and 114 through links 117 and 119, respectively. The links 117, 119 may be dedicated telephone lines, optical fiber links, microwave communication links, or other types of links well known in the art. Similarly, the BSCs 112 and 114 are coupled to the BTSs 104, 106, and 108 by links 118, 116, and 115, respectively. In the present example, each of the BTSs 104, 106 and 108 are in communication with the mobile unit 110. Arrows 120a-120b represent a radio frequency (“RF”) communication link between the BTS 104 and the mobile unit 110. Arrows 126a-126b represents a RF communication link between the BTS 108 and the mobile unit 110. Arrows 124a-124b represents a RF communication link between the BTS 106 and the mobile unit 110.

Exemplary Method and Software

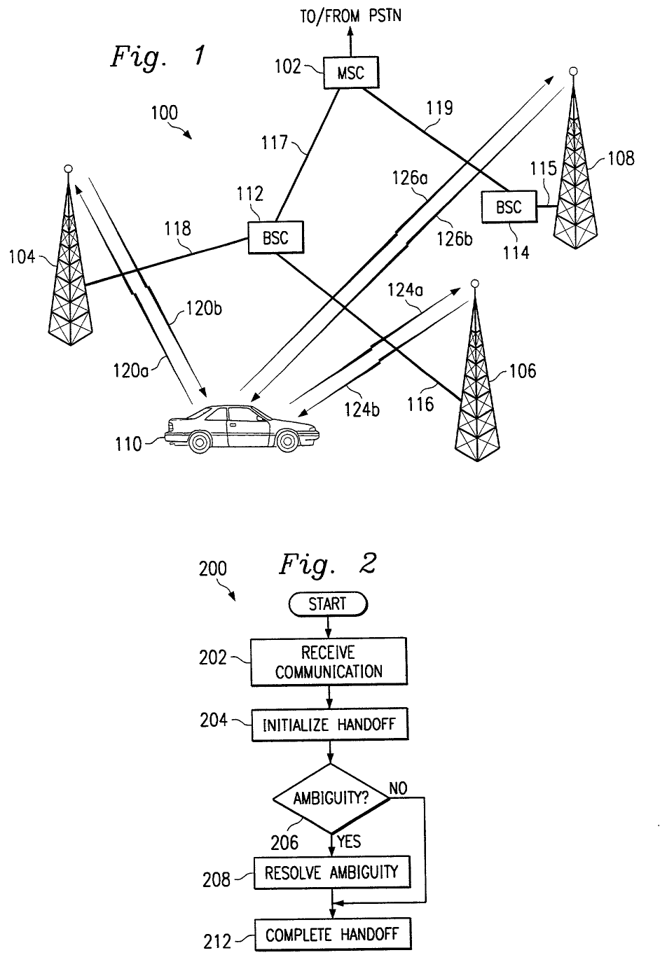

Referring now to FIG. 2, a method 200 can be used during a handoff in the wireless communication network 100 of FIG. 1. In the present example, the handoff is a soft handoff according to CDMA protocol and is performed between an active BTS (e.g., BTS 104) and one of two neighboring BTSs (e.g., BTS 106 and 108). A neighboring BTS is one that provides a pilot signal of sufficient strength on the current CDMA frequency assignment.

Execution begins at step 202, where the active BTS 104 receives a communications signal or a Pilot Strength Measurement Message (“PSMM”) from the mobile unit 110. The PSMM was sent because the mobile unit 110 detected a pilot strength that exceeds a predetermined threshold (e.g., a Soft Handoff Add Threshold). The PSMM includes the PN phases and signal strengths of pilots in the active and candidate sets. The “active set” is the set of pilots associated with the Forward Traffic Channels assigned to the mobile unit 110. The “candidate set” is the set of pilots, not in the active set, but with sufficient strength to indicate that the Forward Traffic Channels could be successfully demodulated.

In the present example, the pilot signal 124b from BTS 106 is of sufficient strength for the BSC 112 to initiate a handoff process. Therefore, at step 204, a handoff process is initialized to add the neighboring BTS 106.

At step 206, a determination is made as to whether there is an ambiguity. An ambiguity occurs, for example, when the phase offset from the pilot signal 124b is in at least two neighbor search windows for two neighboring base station transceivers BTS 106 and 108. The size of the neighbor search window is a user-definable parameter “SRCH_WIN_N.”

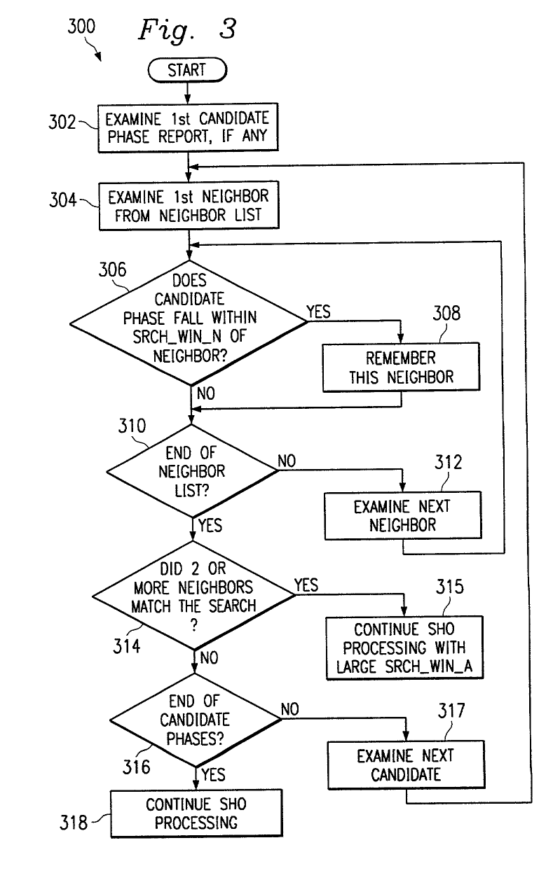

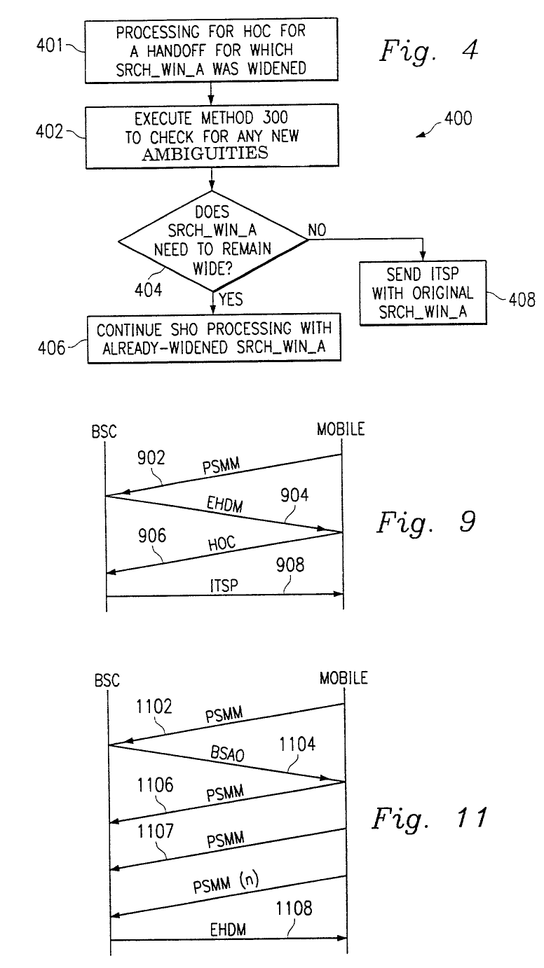

If at step 206, it is determined that an ambiguity exists, execution proceeds to step 208 where processes are run to resolve the ambiguity. In one embodiment, discussed below with reference to FIGS. 3 and 4, the mobile unit 110 is instructed to increase the size of an active search window. An active search window (SRCH_WIN_A) is a parameter representing the window that the mobile unit 110 uses to search for pilots in the active or candidate set. By increasing the size of the active search window, any ambiguous pilot signals for the neighboring BTSs will be detected. In an alternative embodiment, discussed below with reference to FIG. 10, the handoff process is paused until the phase offset for the pilot signal of all of ambiguous neighboring BTSs have been received.

Execution then proceeds to step 212 where the handoff is completed in a conventional manner.

Embodiments Using an Expanding Active Window

Referring to FIG. 3, one way to resolve the ambiguity detected at step 206 of FIG. 2 is to use a method 300 for expanding an active search window for the mobile unit 110. The method 300 resolves the ambiguity situation by increasing the size of a search window when an ambiguity is found.

Execution of the method 300 begins in step 302, where the BSC 112 retrieves the first candidate “i” phase offset from the candidate phase offsets reported in the PSMM (received in step 202 of FIG. 2). In step 304, the method retrieves a first neighbor “n” from the appropriate neighbor list (e.g., a list including the set of neighboring pilots). In step 306, the method determines whether the phase offset for candidate “i” falls within the SRCH_WIN_N of the neighbor “n.” If the candidate phase “i” falls within the SRCH_WIN_N of the neighbor “n,” in step 308, a flag for this neighbor is set. If not, in step 310, the method determines if this is the end of the neighbor list. If it is not the end of the neighbor list, in step 312, the next neighbor is examined (e.g., n is incremented by one), and the method logic returns to step 306.

On the other hand, if in step 310 the method determines that the end of the neighbor list has been reached, in step 314, a check is made to determine whether two or more flags have been set (from step 308). If two or more flags have been set, the method 300 determines that there is an ambiguity. In step 315 the active search window is enlarged, and a soft handoff processing (SHO) continues with an increased active search window SRCH_WIN_A. In one embodiment, SRCH_WIN_A is increased to the size of the neighbor search window SRCH_WIN_N.

In contrast, if two or more flags have not been set, the method in step 316 determines whether this is the end of the candidate phase list. If it is the end of the candidate phase list, in step 318, the method continues normal soft handoff processing using the default value of SRCH_WIN_A. If it is not at the end of the list, in step 317, the next candidate is retrieved and variables are initialized (e.g., the candidate variable “i” is incremented by one, the neighbor list variable “n” is reset to one, and the flags used step 308 are reset) and the method logic returns to step 304.

After the handoff is complete (the mobile unit 110 sends a Hand-Off Complete “HOC” message to BSC 112), if the mobile does not also request to drop the new pilot from the candidate phase report, the SRCH_WIN_A may be restored by specifying a new width via an In-Traffic System Parameter Message (“ITSP”).

FIG. 4 is a flowchart illustrating a method 400 of returning the active search window SRCH_WIN_A to its original size. This process begins after the HOC message has been received, as in step 401. In step 402, the method 300 of FIG. 3 is executed again to determine if there are any new ambiguities. Step 404 determines whether a new ambiguity has been found. If a new ambiguity has been found, the soft hand off processing continues in step 406 with the existing width of the SRCH_WIN_A (i.e., the larger width). On the other hand, if a new ambiguity was not found, in step 408, the original width of SRCH_WIN_A is restored by sending the mobile unit 110 an ITSP with the smaller width parameter for the SRCH_WIN_A.

Referring again to FIG. 1, in an example scenario, the mobile unit 110 distinguishes between the pilot signals 120b, 124b, 126b by the PN number associated with each signal. Each pilot signal 120b, 124b, 126b is of the same PN spreading code, but with a different code phase or time offset, specified in chips. For example, there may be 511 different offsets from the zero offset, where the offsets are in increments of 64 PN chips. In this example, each chip is 814 nanoseconds. It is this phase offset that allows the mobile unit to distinguish between the pilot signals from BTSs 104, 106 and 108. Use of the same pilot signal code allows the mobile unit 110 to find system timing synchronization by a single search through all pilot signal code phases.

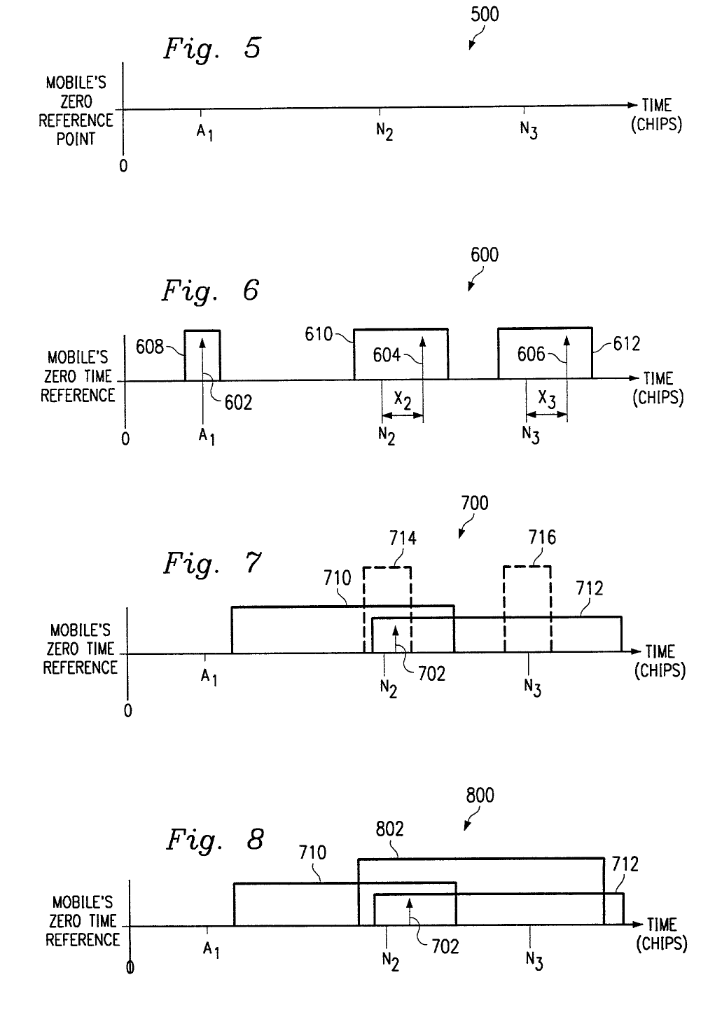

Referring now to FIG. 5, the phase or PN number can be visualized in the form of a time line 500 from the mobile unit's zero time reference. The time line 500 shows where several different signal values A₁, N₂, and N₃ should be received by the mobile units 110. A₁ represents the PN for signal 120a of BTS which is currently in communication with BTS 104. Because BTS 104 is in active communication via forward communication channels with the mobile unit 110, A₁ is in the mobile unit's 110 “active set.” In contrast, N₂ represents the PN for signal 124b of the neighboring BTS 106, and N₃ represents the PN for signal 126b of the neighboring BTS 108. Signals N₂ and N₃ are in the neighbor set of the mobile unit 110 because the mobile unit receives the signals from these BTSs, but is not in active communication with the BTSs.

However, the signals 120b, 124b, and 126b may not always be received by the mobile at precisely the exact PN along the time line 500 because of the travel time of the radio signal. Furthermore, the signal path is not always straight and may bounce off of buildings or other structures causing additional delays. Consequently, the mobile unit may actually see the pilot signal at different chips from its time reference point. The BSC 112, therefore, directs the mobile unit to look in a search window.

Referring now to FIG. 6, a time line 600 shows when the pilot signals are received by the mobile unit 110. A pilot signal 602 represents the actual pilot signal peak received for signal 120b. A pilot signal 604 represents the actual pilot signal peak received for signal 124b, and a pilot signal 606 represents the actual pilot signal peak received from signal 126b. As explained previously, because of travel time and obstacles, the neighboring signal 124b is actually received at a time X₂ from N₂. Similarly, neighboring signal 126b is actually received by the mobile unit 110 at a time X₃ from N₃. Thus, the mobile will report these values in PSMM to BTS 104 as: [(N₂×64)+X₂ chips] for signal 124b and [(N₃×64)+X₃ chips] for signal 126b.

Pilot signal 602 is within an active window 608. The search windows for the pilots from the neighboring set are indicated as search windows 610 and 612. Search window 610 corresponds to the parameter SRCH_WIN_N for N₂, and search window 612 corresponds to the parameter SRCH_WIN_N for N₃. Because signal 604 is within search window 610, the mobile unit 110 associates signal 604 with N₂, and thus with BTS 106. Similarly, because signal 606 is within search window 612, the mobile unit 110 associates the pilot signal 604 with N₃, and thus with BTS 108.

As illustrated in FIG. 6, the search window 608 is smaller than search windows 610 and 612. Search window 608 represents the active search window or the parameter SRCH_WIN_A. An active search window is used to demodulate energy from pilot energies actively involved in the soft hand off. Because active search windows use system resources, they are typically smaller than neighbor search windows.

FIG. 7 is a time line 700 illustrating a situation where an actual pilot signal falls within overlapping search windows. This situation creates an ambiguity. The actual pilot signal is represented along the time line by pilot signal 702. Search window 710 represents the SRCH_WIN_N for N₂. Similarly, search window 712 represents the SRCH_WIN_N for N₃. The mobile unit 110 reports pilot signal 702 in terms relative to the mobile unit 110's zero time offset. The BSC 112 responds, however, in terms of PN numbers and may respond with either N₂ or N₃. Meanwhile, the mobile unit 110 has already associated pilot signal 702 with either N₂ or N₃. By way of example, assume the BSC 112 determines that the pilot signal 702 belongs to N₂. The BSC 112 will send an Extended Handoff Direction Message or “EHDM” to the mobile unit 110 instructing the mobile unit 110 to place an active search window 716 around N₂. If this is the first time the mobile unit 110 sees the pilot signal 702, the mobile unit is only aware of one PN, and will associate the pilot signal 702 with either N₂ or N₃. If the mobile unit 110 has associated pilot signal 702 with N₂, it will place the active search window 714 at zero offset from N₂ and the soft handoff will work.

On the other hand, if the BSC 112 determines that the pilot signal 702 belongs to N₂ and the mobile unit 110 associates the pilot signal 702 with N₃, it will place its active search window 716 around N₃. However, there is no signal (e.g., pilot signal 702) within search window 716. The communication link will be broken, and the soft handoff will fail.

In contrast, FIG. 8 is the time line 800 where a widened search window has been employed according to one embodiment of the present invention. The actual pilot signal is again represented along the time line by pilot signal 702. Search window 710 represents the SRCH_WIN_N for N₂. Similarly, search window 712 represents the SRCH_WIN_N for N₃. However, the BSC 112 has now recognized the ambiguity and, in response has increased SRCH_WIN_A in the EHDM to the mobile unit 110. In response, the mobile unit 110 will place an enlarged search window 802 around either N₂ or N₃. In either situation, the search window 802 is now large enough so that the mobile unit 110 can find pilot signal 702. Thus, the soft handoff will work and normal handoff processing can continue.

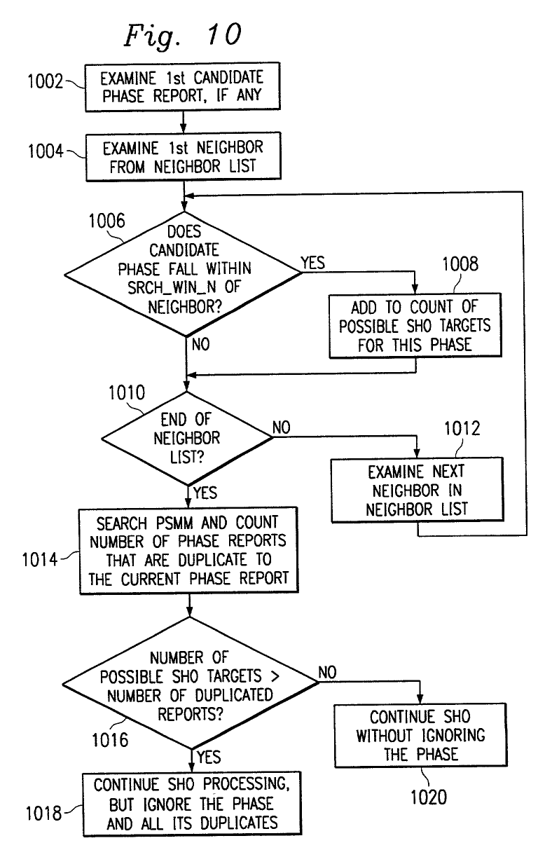

FIG. 9 illustrates an overview of a communications flow between the BSC 112 and the mobile unit 110 in such a situation. As previously discussed, when the mobile unit 110 finds a sufficiently strong pilot energy in a neighbor search, the mobile 110 sends to the BSC 112 a PSMM 902. The PSMM 902 includes the phase offsets in chips of the pilot signal seen by the mobile 110. The PSMM 902 will include the phase offsets for the pilot signal from both the candidate set and the active set. By executing one embodiment of the present invention, the BSC will determine if an ambiguity exists by determining whether the pilot signal in the candidate set is located in areas where the SRCH_WIN_N from two or more neighbors overlap. If an ambiguity exists, the BSC 112 widens the parameter SRCH_WIN_A and sends an EHDM 904 including the new SRCH_WIN_A parameter.

The mobile unit 110 then continues with the normal soft handoff processing using the parameters specified in the EHDM 904. Because a wide SRCH_WIN_A uses the mobile unit 110's resources, the width of SRCH_WIN_A should be restored when the handoff is complete. Referring back to FIG. 9, after the handoff is complete, the mobile unit 110 will send BSC 112 a HOC 906 (i.e., a handoff complete message). The default SRCH_WIN_A may then be restored executing the method 400, illustrated in FIG. 4. The parameter SRCH_WIN_A is specified via an In-Traffic System Parameter Message (“ITSP”) 908.

Embodiments Using a Wait Routine

Referring to FIG. 10, another way to resolve the ambiguity detected at step 206 of FIG. 2 is to use a method 1000 for waiting until the ambiguity is resolved. The method 1000 resolves the ambiguity situation by waiting until the phase offset from all of the ambiguous neighboring base station transceivers have been received.

Execution of the method 1000 begins in step 1002, where the BSC 112 examines the first candidate reported in a PSMM, if any. In step 1004, the method examines the first neighbor “n” from the appropriate neighbor list. In step 1006, the method determines whether the candidate phase falls within the SRCH_WIN_N of the neighbor “n.” If the candidate phase falls within the SRCH_WIN_N of the neighbor “n,” in step 1008, a counter of possible soft handoff targets is incremented by one. If not, in step 1010, the method determines if this is the end of the neighbor list. If it is not the end of the neighbor list, in step 1012, the next neighbor is examined (e.g., the variable n is incremented by one), and the method logic returns to step 1006.

On the other hand, if the method is at the end of the neighbor list, in step 1014, the method examines the PSMM and counts the number of phase reports that are the duplicates of the current phase report. In step 1016, the number of duplicate phase reports (Nd) from step 1014 is compared to the number of possible soft handoff targets (Ns) counted in step 1008. If Ns is greater than Nd, then in step 1018, the soft handoff processing continues, but the current candidate phase and all of its duplicates are ignored. On the other hand, if Ns is equal to Nd, in step 1020 the soft handoff processing continues without ignoring the current phase. It should also be noted that soft handoff processing may also include rerunning the method 1000 for other candidate phases reported in the PSMM.

Referring now to FIG. 11, in an example scenario, the mobile unit 110, as with the previous scenario, sends the BSC a PSMM 1102 including the phase offsets of the pilot signals of the candidate and active sets. The BSC determines whether there is an ambiguity by determining if any of candidate phases are located in areas where the search windows from neighboring PNs overlap. If there is an ambiguity, the BSC will respond to the mobile unit with a Base Station Acknowledgment Order (“BSAO”) 1104, and additional soft handoff processing will not be performed. The BSC will then wait for additional PSMMs (e.g., PSMM 1106, PSMM 1107, and PSMM(n)), which will eventually report a number greater than the original phase offsets reported in PSMM 1102. After the mobile unit has received all of the pilot energies for all of the ambiguous neighboring PNs, the BSC will then respond with an EHDM 1108 including the neighbor that should be added to the active set. Because the mobile has now searched all reported phases for all neighbors, the mobile will know where to place the active search window SRCH_WIN_A.

Thus, by executing the above method, the BSC 112 can make an intelligent decision to ignore some or all of the phase information in the PSMM until the mobile unit has time to search all of the ambiguous neighbors. As a result, the SRCH_WIN_A placement will be more accurate.

Although illustrative embodiments of the invention have been shown and described, other modifications, changes, and substitutions are intended in the foregoing disclosure. For instance, the present invention is equally applicable to direct Inter-BSC soft handoff processing (e.g., soft handoffs between BSCs). Accordingly, it is appropriate that the appended claims be construed broadly and in a manner consistent with the scope of the invention.

What is claimed:

1. A method for performing a handoff in a wireless communication system between a primary base station transceiver and a first one of at least two neighboring base station transceivers, the method comprising:
receiving a communications signal from a mobile unit, wherein the communications signal includes a phase offset from a pilot signal from the first neighboring base station transceiver,
beginning a handoff process,
detecting if an ambiguity exists by determining if the phase offset is in a neighbor search window for both neighboring base station transceivers,
if the ambiguity exists, resolving the ambiguity by associating the phase offset with the first neighboring base station transceiver, and
completing the handoff process to the first neighboring base station transceiver.

2. The method of claim 1 wherein the step of resolving the ambiguity includes instructing the mobile unit to increase an active search window, and the method further comprising:
if the active search window was increased, decreasing the active search window after completion of the handoff process.

3. The method of claim 1 wherein the step of resolving the ambiguity includes pausing the handoff processing until phase offsets for pilot signals from all ambiguous neighboring base station transceivers have been received, wherein the ambiguous neighboring base station transceivers include the at least two neighboring base station transceivers.

4. The method of claim 1 wherein the detecting step is performed by a first base station controller in communication with the primary base station transceiver.

5. The method of claim 4 wherein the handoff is between the primary base station transceiver and a neighboring base station transceiver controlled by a second base station controller.

6. The method of claim 1 wherein the handoff is a soft handoff.

7. The method of claim 6 wherein the handoff processing follows CDMA protocols.

8. A method for performing a handoff in a wireless communication system having at least one base station controller, at least one primary base station transceiver in communication with a mobile unit, and a plurality of neighboring base station transceivers, the method comprising:
(a) receiving at least one communications message from the mobile unit, wherein the communications message includes a phase offset from at least one pilot signal from a first one of the plurality of neighboring base station transceivers to the mobile unit;
(b) beginning handoff processing for the mobile unit with a second one of the plurality of neighboring base station transceivers;
(c) detecting an ambiguity by determining that the phase offset is within a search window for both the first and second neighboring base station transceivers;
(d) resolving the ambiguity for subsequent handoff processing; and
(e) completing the handoff processing;

9. The method of claim 8 wherein the step of resolving the ambiguity includes increasing an active search window.

10. The method of claim 9 further comprising:
decreasing the active search window upon completing the handoff processing.

11. The method of claim 9 further comprising:
repeating steps (a) through (c),
maintaining the active search window if another ambiguity is detected, and
decreasing the active search window upon completing the handoff processing if another ambiguity is not detected.

12. The method of claim 8 wherein the step of resolving the ambiguity includes pausing the handoff processing until a phase offset for pilot signals from all of the plurality of neighboring base station transceivers have been received.

13. The method of claim 8 wherein the detecting step is performed by a first base station controller in communication with the primary base station transceiver.

14. The method of claim 8 wherein the handoff processing is performed by the primary base station transceiver and a neighboring base station transceiver controlled by a second base station controller.

15. The method of claim 8 wherein the handoff is a soft handoff.

16. The method of claim 8 wherein the handoff processing follows CDMA protocols.

17. A method for performing a wireless connection of a mobile unit in a wireless communication system having a plurality of neighboring transceivers, the method comprising:
compiling a neighbor list from the plurality of neighboring transceivers,
receiving at least one identifier provided by at least one signal originating from one of the neighboring transceivers,
beginning a connection process to the one neighboring transceiver,
determining whether the signal is in search windows for two or more of the neighboring transceivers,
if the signal is in search windows for two or more of the neighboring transceivers, pausing the connection process until the number of signals received is greater than or equal to a number of neighbors in the neighbor list.

18. The method of claim 17 wherein the determining step is performed by a first controller in communication with the transceivers.

19. The method of claim 17 wherein the connection process is performed by a primary transceiver currently in communication with the mobile unit.

20. The method of claim 17 wherein the connection process utilizes a soft handoff.

21. The method of claim 20 wherein the soft handoff follows CDMA protocols.

22. A base station controller comprising:
means for receiving at least one communications message originating from a mobile unit, wherein the communications message includes a spreading code (PN) phase offset from at least one pilot signal from one of a plurality of neighboring base station transceivers,
means for initiating a handoff process between a primary base station in communication with the mobile unit and the controller, and at least one of the plurality of neighboring base stations,
means for detecting an ambiguity by determining whether PN phase offset is within two or more search windows for at least two of the neighboring base station transceivers,
means for resolving the ambiguity, and
means for completing the handoff process with at least one of the plurality of neighboring base station transceivers when the ambiguity is resolved.

23. The controller of claim 22 wherein the base station controller further comprises means for enlarging an active search window upon detecting the ambiguity.

24. The controller of claim 23 further comprising:
means for decreasing the active search window after completion of the handoff processing.

25. The controller of claim 23 further comprising:
means for detecting another ambiguity,
means for maintaining the active search window, if another ambiguity is detected, and
means for decreasing the active search window if another ambiguity is not detected.

26. The controller of claim 22 wherein the means for resolving the ambiguity includes means for pausing the handoff processing until the ambiguity resolves.

27. A node in a wireless telecommunications network comprising:
a receiver device for receiving at least one communications message including a value from a signal from one of a plurality of neighboring transceivers,
handoff circuitry for initiating a handoff between a primary base station in communication with a mobile unit and a base station associated with one of the plurality of neighboring transceivers, and
a processor including software for detecting an ambiguity by determining whether the signal is within at least two signal search windows for at least two of the neighboring transceivers, for resolving the ambiguity.
